(19) United States
(12) Patent Application Publication
(10) Pub. No.: US 2018/0316477 A1
(43) Pub. Date: Nov. 1, 2018

(54) GROUP ACKNOWLEDGMENT AND/OR NEGATIVE ACKNOWLEDGMENT IN WIRELESS COMMUNICATION SYSTEMS

(71) Applicant: QUALCOMM Incorporated, San Diego, CA (US)

(72) Inventors: Heechoon LEE, San Diego, CA (US); Wanshi CHEN, San Diego, CA (US)

(21) Appl. No.: 15/962,797

(22) Filed: Apr. 25, 2018

Related U.S. Application Data
(60) Provisional application No. 62/490,335, filed on Apr. 26, 2017.

(51) Int. Cl. H04L 5/00; H04W 72/04; H04L 1/18

(52) U.S. Cl. CPC H04L 5/0055; H04W 72/14; H04L 1/1893; H04W 72/0413

(57) ABSTRACT

The present disclosure relates to efficient transmission of acknowledgment (ACK) and negative ACK (NACK) information in a wireless communication system. For example, a user equipment (UE) may transmit, on an uplink communication channel, one or more data packets to a network entity. The UE may further receive, on a downlink communication channel, a clustered ACK/NACK indication from the network entity in response to transmitting the one or more data packets on the uplink communication channel. Additionally, for instance, a network entity may receive, on an uplink communication channel, one or more data packets from a user equipment. The network entity may also transmit, on a downlink communication channel, a clustered ACK/NACK indication from the network entity in response to receiving the one or more data packets on the uplink communication channel.

### CROSS-REFERENCE TO RELATED APPLICATION(S)

This application claims the benefit of U.S. Provisional Application Ser. No. 62/490,335, entitled “GROUP ACKNOWLEDGMENT AND/OR NEGATIVE ACKNOWLEDGMENT IN WIRELESS COMMUNICATION SYSTEMS” and filed on Apr. 26, 2017, which is expressly incorporated by reference herein in its entirety.

### BACKGROUND

Aspects of the present disclosure relate generally to wireless communication networks, and more particularly, to grouping acknowledgments (ACKs) and/or negative acknowledgments (NACKs) in wireless communications systems such as new radio.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-low latency (ULL) and/or ultra-reliable-low latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in NR communications technology and beyond may be desired.

For example, for NR communications technology and beyond, ACK/NACK transmission on a downlink control channel may inhibit a desired level of speed or customization for efficient operation. Thus, improvements in wireless communication operations may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the present disclosure includes a method for wireless communications at a user equipment (UE). The method may include transmitting, on an uplink communication channel, one or more data packets to a network entity. The method may further include receiving, on a downlink communication channel, a clustered acknowledgment (ACK)/negative ACK (NACK) indication from the network entity in response to transmitting the one or more data packets on the uplink communication channel.

In another aspect, the present disclosure includes a UE for wireless communication comprising a memory and at least one processor in communication with the memory. The at least one processor may be configured to transmit, on an uplink communication channel, one or more data packets to a network entity. The at least one processor may further be configured to receive, on a downlink communication channel, a clustered ACK/NACK indication from the network entity in response to transmitting the one or more data packets on the uplink communication channel.

In an additional aspect, the present disclosure includes a UE for wireless communication. The UE may include means for transmitting, on an uplink communication channel, one or more data packets to a network entity. The UE may further include means for receiving, on a downlink communication channel, a clustered ACK/NACK indication from the network entity in response to transmitting the one or more data packets on the uplink communication channel.

In yet another aspect, the present disclosure includes a computer-readable medium storing computer executable code for wireless communications at a UE. The computer-readable medium may include code for transmitting, on an uplink communication channel, one or more data packets to a network entity. The computer-readable medium may further include code for receiving, on a downlink communication channel, a clustered ACK/NACK indication from the network entity in response to transmitting the one or more data packets on the uplink communication channel.

In an aspect, the present disclosure includes a method for wireless communications at a network entity. The method may include receiving, on an uplink communication channel, one or more data packets from a UE. The method may further include transmitting, on a downlink communication channel, a clustered ACK/NACK indication from the network entity in response to receiving the one or more data packets on the uplink communication channel.

In another aspect, the present disclosure includes a network entity for wireless communication comprising a memory and at least one processor in communication with the memory. The at least one processor may be configured to receive, on an uplink communication channel, one or more data packets from a UE. The at least one processor may further be configured to transmit, on a downlink communication channel, a clustered ACK/NACK indication from the network entity in response to receiving the one or more data packets on the uplink communication channel.

In an additional aspect, the present disclosure includes a network entity for wireless communication. The network entity may include means for receiving, on an uplink communication channel, one or more data packets from a UE. The network entity may further include means for transmitting, on a downlink communication channel, a clustered ACK/NACK indication from the network entity in response to receiving the one or more data packets on the uplink communication channel.

In yet another aspect, the present disclosure includes a computer-readable medium storing computer executable code for wireless communications at a network entity. The computer-readable medium may include code for receiving, on an uplink communication channel, one or more data packets from a UE. The computer-readable medium may further include code for transmitting, on a downlink communication channel, a clustered ACK/NACK indication from the network entity in response to receiving the one or more data packets on the uplink communication channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example wireless communication network including at least one base station having an acknowledgment (ACK)/negative ACK clustering component and at least one user equipment (UE) having a retransmission component;

FIGS. 2A-2C are flow diagrams of an example of a method of wireless communication at a UE;

FIG. 3 is a flow diagram of an example of a method of wireless communication at a network entity;

FIG. 4 is a schematic diagram of example components of the UE of FIG. 1; and

FIG. 5 is a schematic diagram of example components of the base station of FIG. 1.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The present disclosure generally relates to acknowledgment (ACK)/negative ACK (NACK) grouping in new radio wireless communication systems. Specifically, in such wireless communication systems, grant-free uplink transmissions may be utilized in addition to grant-based uplink transmission (e.g., downlink control information (DCI)). In an example, for grant-free transmissions, a downlink physical communication channel carrying ACK/NACK may be desirable rather than employing a larger DCI. However, in some instances, a physical hybrid automatic repeat request (ARQ) indicator (PHICH) channel, or a similar channel, may not be available in a new radio wireless communication system. Additionally, it may be inefficient to deliver a very small payload corresponding to one or more ACKS/NACKs in a physical downlink control channel (PDCCH) due to coding inefficiencies. As such, there is a need to efficiently transmit ACK/NACK information (e.g., without a full DCI) in response to a grant-free UL transmission.

Accordingly, the present aspects may provide grouping of ACK/NACK information. For example, in some aspects, a user equipment (UE) may transmit, on an uplink communication channel, one or more data packets to a network entity. Further, the UE may receive, on a downlink communication channel, a clustered ACK/NACK indication from the network entity in response to the transmission of the one or more data packets on the uplink communication channel. Additionally, in some aspects, a network entity may receive, on an uplink communication channel, one or more data packets from a UE. Moreover, the network entity may transmit, on a downlink communication channel, a grouped ACK/NACK indication from the network entity in response to receiving the one or more data packets on the uplink communication channel.

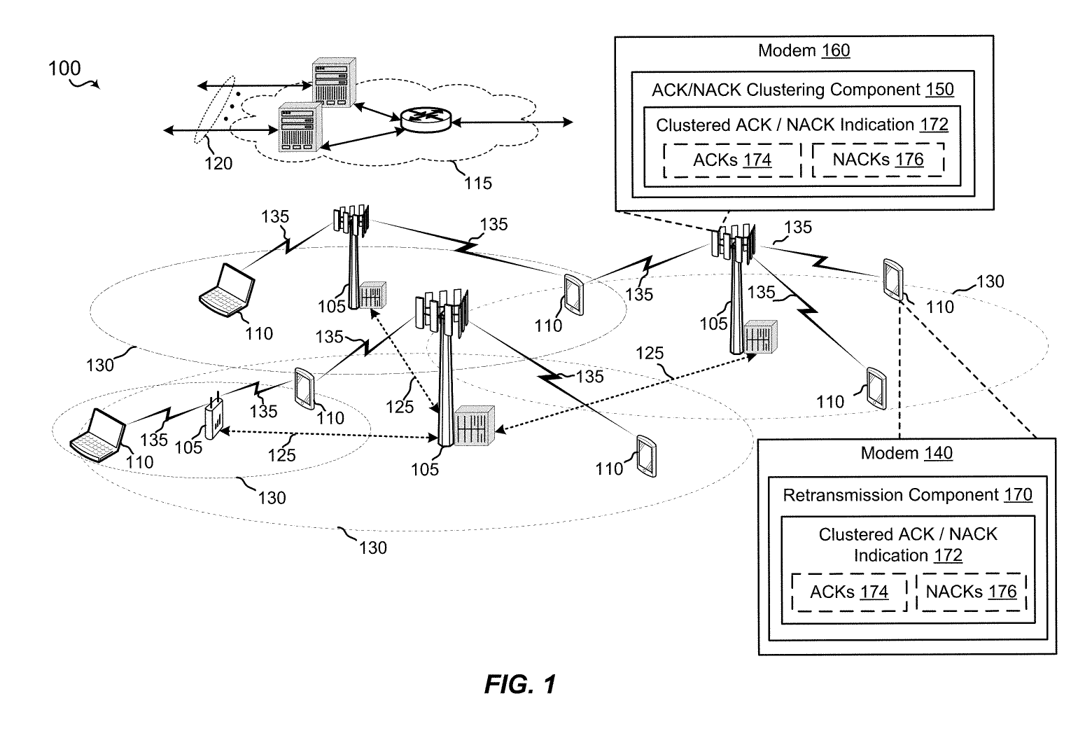

Additional features of the present aspects are described in more detail below with respect to FIGS. 1-5.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to 5G networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Referring to FIG. 1, in accordance with various aspects of the present disclosure, an example wireless communication network 100 may include at least one UE 110 with a modem 140 having a retransmission component 170 that may receive a clustered ACK/NACK indication 172 and may retransmit data according to the information in the clustered ACK/NACK indication 172. In some aspects, assuming clustering of N ACK/NACK bits (either for multi-UE or multi-mini-slot, each bit may represent ACK or NACK), the clustered ACK/NACK indication 172 may become N bits. Each UE 110 or mini-slot may be configured with an index of the N bits. For example, if the UE 110 is configured with the i-th bit, the UE 110 may decode the clustered N-bit and refer to the i-th bit to extract one or more ACKs 174 or NACKs 176.

Further, wireless communication network 100 may include at least one base station 105 with a modem 160 including an ACK/NACK clustering component 150 that groups or clusters one or more ACKs 174/NACKs 176 for transmission to the UE 110 via or within a clustered ACK/NACK indication 172.

Thus, according to the present disclosure, to efficiently transmit ACK/NACK information to the UE 110, the ACK/NACK clustering component 150 may group or cluster ACK/NACK information according to at least one of a multi-UE scheme or a multi-mini-slot scheme. For both the multi-UE scheme and the multi-mini-slot scheme, the UE 110 may transmit grant-free data on the uplink.

Specifically, the multi-UE scheme may configure multi-UE ACK/NACK transmissions in response to grant-free uplink data transmission from multiple UEs. For example, in some aspects, grant-free transmissions may be performed in accordance with synchronous or asynchronous hybrid automatic repeat request (HARQ). Further, the timing between transmission on the physical uplink shared channel (PUSCH) and corresponding ACK/NACK transmissions on the downlink may be pre-determined for grant-free retransmission. In some aspects, for grant-based retransmissions, the clustered ACK/NACK indication 172 may be coupled with a HARQ process identifier.

Moreover, each UE, including UE 110, may be configured with an index in the clustered ACK/NACK indication 172. For instance, indexing in the clustered ACK/NACK indication 172 may be derived based on a radio resource control (RRC) configuration. Alternatively or in addition, indexing may be a function of the PUSCH transmission (e.g., as a function of the starting physical resource block (PRB) of PUSCH, and/or the starting symbol index of PUSCH and/or the cyclic shift of PUSCH).

In some aspects, the clustered ACK/NACK indication 172 may be individually configured for each of the mini-slots forming a slot for the UE 110. Alternatively, a single clustered ACK/NACK indication 172 may be used for all the mini-slots forming the slot. In other words, ACK/NACK bundling or clustering may be employed for responding within multiple mini-slots (e.g., sending a NACK in the event at least one mini-slot includes a NACK).

in the case of uplink multiple-input multiple-output (MIMO), the clustered ACK/NACK indication 172 may be transmitted per codeword or as a single clustered ACK/NACK indication 172 for both codewords (e.g., spatial bundling). In the case of subband, the clustered ACK/NACK indication 172 may also be subband dependent. However, indexing in the group or cluster HARQ may be configured separately for each subband.

The multi-mini-slot scheme may configure multi-UE ACK/NACK transmissions in response to grant-free uplink data transmission from multiple mini-slots. In some aspects, a mini-slot may be configurable in length and may be as short as a single symbol. Further, in some aspects, a slot length may be in the order of 14/28 symbols.

For example, in some aspects, grant-free transmissions may be performed in accordance with synchronous or asynchronous hybrid automatic repeat request (HARQ). The timing between transmission on the physical uplink shared channel (PUSCH) and corresponding ACK/NACK transmissions on the downlink may be pre-determined for grant-free retransmission. In some aspects, for grant-based retransmissions, the clustered ACK/NACK indication 172 may be coupled with a HARQ process identifier. For instance, a cluster of ACKs 174/NACKs 176 for multi-mini-slots across multiple slots may be bundled.

Each ACK/NACK corresponding to a mini-slot may be configured with an index in the clustered ACK/NACK indication 172. For instance, indexing in the clustered ACK/NACK indication 172 may be derived based on a radio resource control (RRC) configuration. Alternatively or in addition, indexing may be a function of the PUSCH transmission (e.g., as a function of the starting physical resource block (PRB) of PUSCH, and/or the starting symbol index of PUSCH and/or the cyclic shift of PUSCH). For grant-based retransmissions, ACK/NACK transmissions within mini-slots across multiple slots may be grouped or bundled.

In the case of uplink multiple-input multiple-output (MIMO), the clustered ACK/NACK indication 172 may be transmitted per codeword or as a single clustered ACK/NACK indication 172 for both codewords (e.g., spatial bundling). In the case of subband, the clustered ACK/NACK indication 172 may also be subband dependent. However, indexing in the group or cluster HARQ may be configured separately for each subband.

The wireless communication network 100 may further include a UE 110, which may in turn include a retransmission component 170 configured to transmit or retransmit data based on determining whether one or more ACKs 174 or NACKs 176 have been received within the clustered ACK/NACK indication 172 from a base station 105. Specifically, in an example, the UE 110 may receive a transmission including the clustered ACK/NACK indication 172 from the base station 105 on a downlink communication channel. Based on a determination as to whether the clustered ACK/NACK indication 172 includes one or more NACKs 176 (e.g., bundled with at least one other NACK or one or more ACKs 174 of the same or different UE), the UE 110 may transmit or retransmit the missing data packets on an uplink communication channel.

In instances where downlink retransmissions (e.g., HARQ) may be asynchronous (e.g., does not follow a specific timing pattern/schedule), the transmissions/retransmissions may be performed/completed faster via retransmission component 170. Specifically, the retransmission component 170 may not only transmit/retransmit the failed data packets, but also either a new data packets or any other failed data packets having a different HARQ process identifier. Such configuration may apply to LTE communication systems and/or new radio communication systems.

In some aspects, the UE 110 may also include ACK/NACK clustering component 150 for transmission of a clustered ACK/NACK indication 172 on an uplink communication channel to the base station 105. Further, in some aspects, the base station 105 may include a retransmission component 170 for transmission or retransmission, on a downlink communication channel, of data (e.g., data packets) identified as missing within the clustered ACK/NACK indication 172.

The wireless communication network 100 may include one or more base stations 105, one or more UEs 110, and a core network 115. The core network 115 may provide user authentication, access authorization, tracking, internet protocol (IP) connectivity, and other access, routing, or mobility functions. The base stations 105 may interface with the core network 115 through backhaul links 120 (e.g., 51, etc.). The base stations 105 may perform radio configuration and scheduling for communication with the UEs 110, or may operate under the control of a base station controller (not shown). In various examples, the base stations 105 may communicate, either directly or indirectly (e.g., through core network 115), with one another over backhaul links 125 (e.g., X1, etc.), which may be wired or wireless communication links.

The base stations 105 may wirelessly communicate with the UEs 110 via one or more base station antennas. Each of the base stations 105 may provide communication coverage for a respective geographic coverage area 130. In some examples, base stations 105 may be referred to as a base transceiver station, a radio base station, an access point, an access node, a radio transceiver, a NodeB, eNodeB (eNB), gNodeB (gNB), Home NodeB, a Home eNodeB, a relay, or some other suitable terminology. The geographic coverage area 130 for a base station 105 may be divided into sectors or cells making up only a portion of the coverage area (not shown). The wireless communication network 100 may include base stations 105 of different types (e.g., macro base stations or small cell base stations, described below). Additionally, the plurality of base stations 105 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 130 for different communication technologies.

In some examples, the wireless communication network 100 may be or include one or any combination of communication technologies, including a new radio (NR) or 5G technology, a Long Term Evolution (LTE) or LTE-Advanced (LTE-A) or MuLTEfire technology, a Wi-Fi technology, a Bluetooth technology, or any other long or short range wireless communication technology. In LTE/LTE-A/MuLTEfire networks, the term evolved node B (eNB) may be generally used to describe the base stations 105, while the term UE may be generally used to describe the UEs 110. The wireless communication network 100 may be a heterogeneous technology network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may generally cover a relatively large geographic area (e.g., several kilometers in radius) and may allow unrestricted access by UEs 110 with service subscriptions with the network provider.

A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by UEs 110 with service subscriptions with the network provider. A femto cell may also cover a small geographic area (e.g., a home) and may provide restricted access and/or unrestricted access by UEs 110 having an association with the femto cell (e.g., in the restricted access case, UEs 110 in a closed subscriber group (CSG) of the base station 105, which may include UEs 110 for users in the home, and the like). A micro cell may cover a geographic area larger than a pico cell and a femto cell, but smaller than a macro cell. An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A user plane protocol stack (e.g., packet data convergence protocol (PDCP), radio link control (RLC), MAC, etc.), may perform packet segmentation and reassembly to communicate over logical channels. For example, a MAC layer may perform priority handling and multiplexing of logical channels into transport channels. The MAC layer may also use hybrid automatic repeat/request (HARQ) to provide retransmission at the MAC layer to improve link efficiency. In the control plane, the RRC protocol layer may provide establishment, configuration, and maintenance of an RRC connection between a UE 110 and the base station 105. The RRC protocol layer may also be used for core network 115 support of radio bearers for the user plane data. At the physical (PHY) layer, the transport channels may be mapped to physical channels.

The UEs 110 may be dispersed throughout the wireless communication network 100, and each UE 110 may be stationary or mobile. A UE 110 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 110 may be a cellular phone, a smart phone, a personal digital assistant (PDA), a wireless modem, a wireless communication device, a handheld device, a tablet computer, a laptop computer, a cordless phone, a smart watch, a wireless local loop (WLL) station, an entertainment device, a vehicular component, a customer premises equipment (CPE), or any device capable of communicating in wireless communication network 100. Additionally, a UE 110 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. A UE 110 may be able to communicate with various types of base stations 105 and network equipment including macro eNBs, small cell eNBs, macro gNBs, small cell gNBs, relay base stations, and the like.

A UE 110 may be configured to establish one or more wireless communication links 135 with one or more base stations 105. The wireless communication links 135 shown in wireless communication network 100 may carry uplink (UL) transmissions from a UE 110 to a base station 105, or downlink (DL) transmissions, from a base station 105 to a UE 110. The downlink transmissions may also be called forward link transmissions while the uplink transmissions may also be called reverse link transmissions. Each wireless communication link 135 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the wireless communication links 135 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2). Moreover, in some aspects, the wireless communication links 135 may represent one or more broadcast channels.

In some aspects of the wireless communication network 100, base stations 105 or UEs 110 may include multiple antennas for employing antenna diversity schemes to improve communication quality and reliability between base stations 105 and UEs 110. Additionally or alternatively, base stations 105 or UEs 110 may employ multiple input multiple output (MIMO) techniques that may take advantage of multi-path environments to transmit multiple spatial layers carrying the same or different coded data.

Wireless communication network 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 110 may be configured with multiple downlink CCs and one or more uplink CCs for carrier aggregation. Carrier aggregation may be used with both FDD and TDD component carriers. The base stations 105 and UEs 110 may use spectrum up to Y MHz (e.g., Y=5, 10, 15, or 20 MHz) bandwidth per carrier allocated in a carrier aggregation of up to a total of Yx MHz (x=number of component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications network 100 may further include base stations 105 operating according to Wi-Fi technology, e.g., Wi-Fi access points, in communication with UEs 110 operating according to Wi-Fi technology, e.g., Wi-Fi stations (STAs) via communication links in an unlicensed frequency spectrum (e.g., 5 GHz). When communicating in an unlicensed frequency spectrum, the STAs and AP may perform a clear channel assessment (CCA) or listen before talk (LBT) procedure prior to communicating in order to determine whether the channel is available.

One or more of base stations 105 and/or UEs 110 may operate according to a NR or 5G technology referred to as millimeter wave (mmW or mmwave) technology. For example, mmW technology includes transmissions in mmW frequencies and/or near mmW frequencies. Extremely high frequency (EHF) is part of the radio frequency (RF) in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. For example, the super high frequency (SHF) band extends between 3 GHz and 30 GHz, and may also be referred to as centimeter wave. Communications using the mmW and/or near mmW radio frequency band has extremely high path loss and a short range. As such, base stations 105 and/or UEs 110 operating according to the mmW technology may utilize beamforming in their transmissions to compensate for the extremely high path loss and short range.

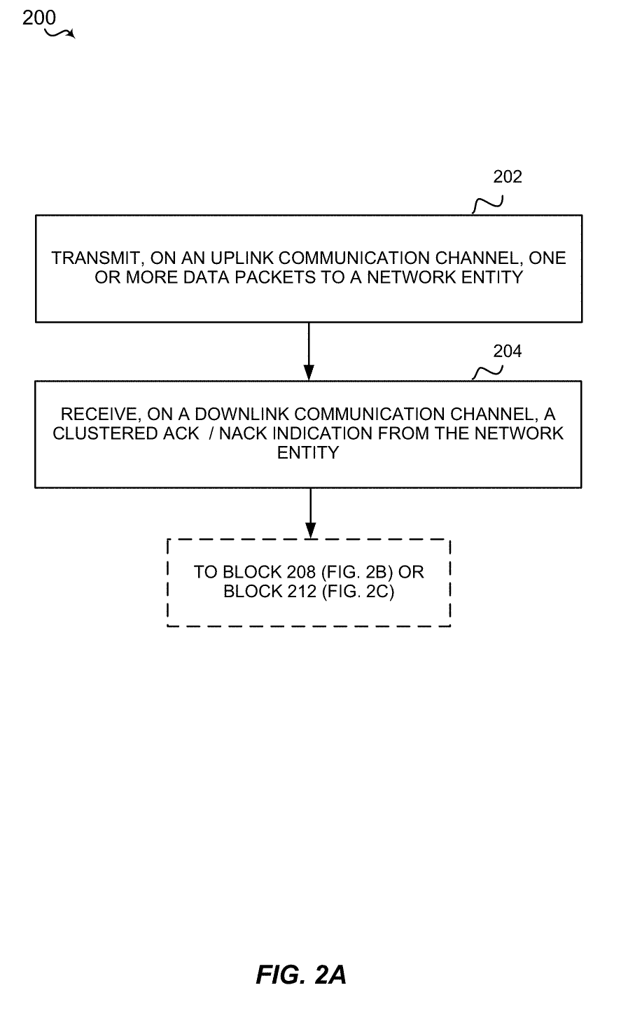

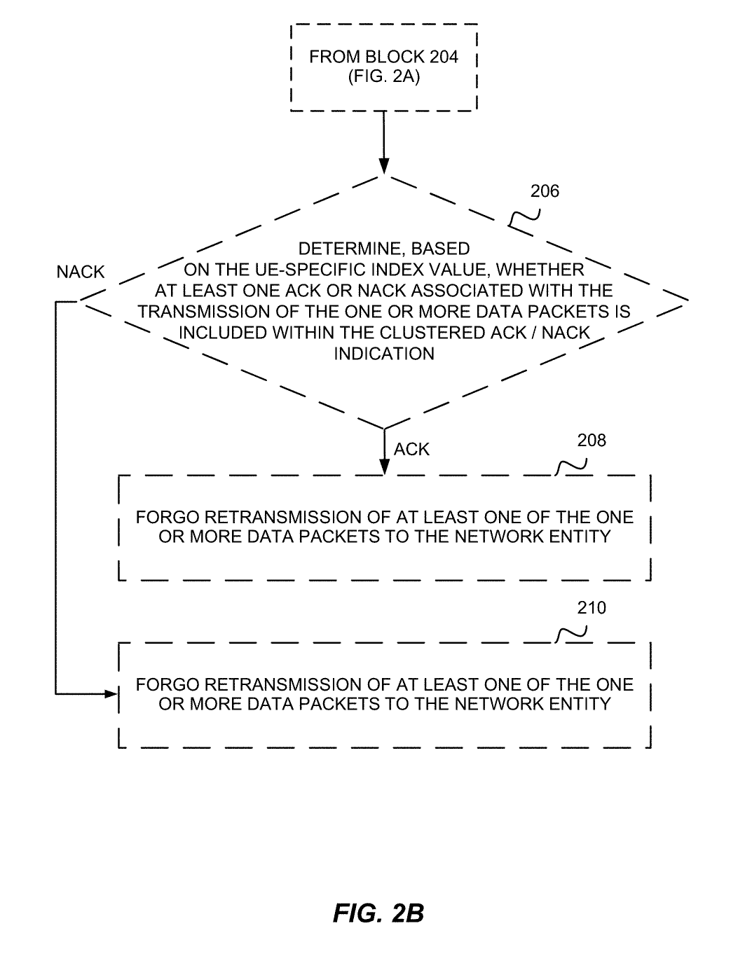

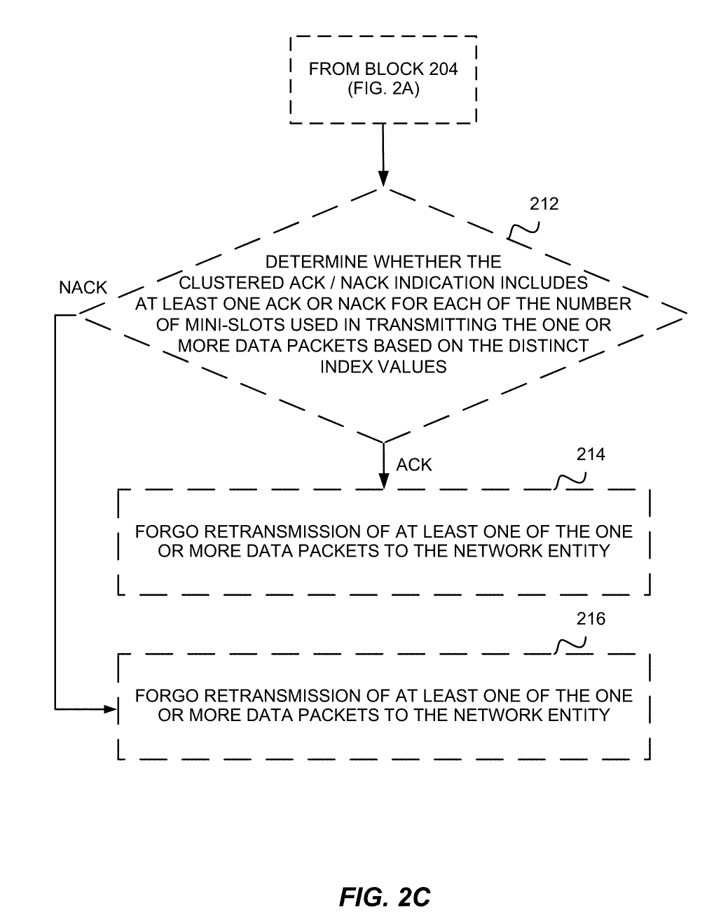

Referring to FIGS. 2A-2C, for example, a method 200 of wireless communication in operating a UE, such as UE 110, according to the above-described aspects to efficiently retransmit data in a new radio environment includes one or more of the herein-defined actions. The blocks illustrated as having dashed lines may be optional.

At block 202, method 200 may transmit, on an uplink communication channel, one or more data packets to a network entity. For example, as described herein, the UE 110 may execute the modem 140 to transmit, on an uplink communication channel, one or more data packets to the base station 105.

In some aspects, the UE 110 may be associated with a UE-specific index value identifying one or more associated ACKs 174 or NACKs 176 within the clustered ACK/NACK indication 172. Further, in some aspects, the clustered acknowledgment ACK/NACK indication 172 may be received within a sequence of mini slots of a slot. In some aspects, the transmission of the one or more data packets on the uplink communication channel corresponds to a grant-free transmission.

At block 204, method 200 may receive, on a downlink communication channel, a clustered ACK/NACK indication from the network entity. For instance, as described herein, the UE 110 may execute the modem 140 to receive, on a downlink communication channel, a clustered ACK/NACK indication 172 from the base station 105 in response to transmitting the one or more data packets on the uplink communication channel. In some aspects, the UE-specific index may be based on at least one of a RRC configuration or a PUSCH transmission.

In some aspects, transmitting, on the uplink communication channel, the one or more data packets to the network entity (e.g., base station 105) may include transmitting the one or more data packets according to a MIMO configuration. In some aspects, receiving, on the downlink communication channel, the clustered ACK/NACK indication 172 from the network entity (e.g., base station 105) may include receiving the clustered ACK/NACK indication 172 per codeword or for both codewords (e.g., according to the MIMO configuration). In some aspects, the clustered ACK/NACK indication 172 may be frequency subband dependent.

In some aspects, the clustered ACK/NACK indication 172 may be received at a predetermined time after transmitting the one or more data packets to the network entity (e.g., base station 105). In some aspects, the clustered ACK/NACK indication 172 may be coupled with a HARQ process identifier.

Further, in some aspects, method 200 may proceed to block 206, where method 200 may determine, based on the UE-specific index value, whether at least one ACK or NACK associated with the transmission of the one or more data packets is included within the clustered ACK/NACK indication. For instance, as described herein, the UE 110 and/or modem 140 may execute retransmission component 170 to determine, based on the UE-specific index value, whether at least one ACK or NACK associated with the transmission of the one or more data packets is included within the clustered ACK/NACK indication 172.

At block 208, method 200 may forgo retransmission of at least one of the one or more data packets to the network entity in accordance with a determination that the clustered ACK/NACK indication includes at least one ACK. For instance, as described herein, the UE 110 and/or modem 140 may execute retransmission component 170 to forgo retransmission of at least one of the one or more data packets to the base station 105.

At block 210, method 200 may retransmit at least one of the one or more data packets to the network entity in accordance with a determination that the clustered ACK/NACK indication includes at least one NACK. For instance, as described herein, the UE 110 and/or modem 140 may execute retransmission component to retransmit at least one of the one or more data packets to the base station 105.

In some aspects, transmitting, on the uplink communication channel, the one or more data packets may include transmitting the one or more data packets within a number of mini-slots. Further, in some aspects, each of the number of mini-slots may be associated with a distinct index value.

In some aspects, method 200 may proceed to block 212, where method 200 may determine whether the clustered ACK/NACK indication includes at least one ACK or NACK for each of the number of mini-slots used in transmitting the one or more data packets based on the distinct index values. For instance, as described herein, the UE 110 and/or modem 140 may execute retransmission component 170 to determine, the clustered ACK/NACK indication 172 includes at least one ACK or NACK for each of the number of mini-slots used in transmitting the one or more data packets based on the distinct index values.

At block 214, method 200 may forgo retransmission of at least one of the one or more data packets to the network entity in accordance with a determination that the clustered ACK/NACK indication includes at least one ACK for at least one of the number of mini-slots. For instance, as described herein, the UE 110 and/or modem 140 may execute retransmission component 170 to forgo retransmission of at least one of the one or more data packets to the base station 105.

At block 216, method 200 may retransmit at least one of the one or more data packets to the network entity in accordance with a determination that the clustered ACK/NACK indication includes at least one NACK for at least one of the number of mini-slots. For instance, as described herein, the UE 110 and/or modem 140 may execute retransmission component to retransmit at least one of the one or more data packets to the base station 105.

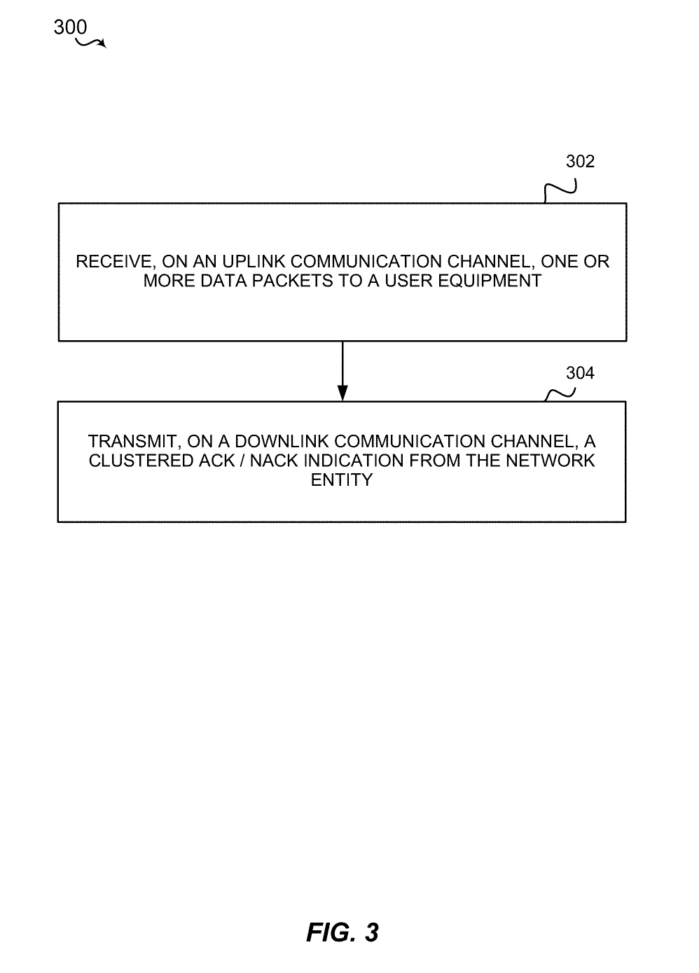

Referring to FIG. 3, for example, a method 300 of wireless communication at a network entity (e.g., base station 105) according to the above-described aspects to transmit a clustered ACK/NACK indication 172 to at least one UE 110 includes one or more of the herein-defined actions. The blocks illustrated as having dashed lines may be optional.

At block 302, the method 300 may receive, on an uplink communication channel, one or more data packets from a UE. For example, as described herein, the base station 105 may execute modem 160 to receive, on an uplink communication channel, one or more data packets from UE 110.

At block 304, the method 300 may transmit, on a downlink communication channel, a clustered acknowledgment (ACK)/negative ACK (NACK) indication from the network entity. For example, as described herein, the base station 105 and/or modem 160 may execute ACK/NACK clustering component 150 to transmit, on a downlink communication channel, a clustered ACK/NACK indication 172 to one or more UEs including UE 110.

In some aspects, transmitting the clustered ACK/NACK indication 172 may include transmitting one or more ACKs 174 or NACKs 176 each of which may be associated with a UE-specific index value. Further, in some aspects, transmitting the clustered ACK/NACK indication 172 may include transmitting one or more ACKs 174 or NACKs 176 each associated with an index value of a corresponding mini-slot.

In some aspects, an ACK may be transmitted when a receiving device receives a data packet. For example, a transmitting device may transmit data in the form of data packets to a receiving device. The receiving device, in order to confirm reception of the data, may transmit one or more ACKs to the transmit device. However, in the event the receiving device failed to receive at least a portion of the data (e.g., one or more data packets), the receiving device may transmit a NACK to indicate to the transmitting device that at least a portion of the data was not received, whereby the transmitting device may determine to retransmit the missing data.

In some aspects, the clustered ACK/NACK indication 172 may be frequency subband dependent. Although not shown, in some aspects, the method 300 may include selecting at least one UE-specific index value for one or more ACKs or NACKs 172 based on a frequency subband of communication. In some aspects, the one or more data packets may be received on the uplink communication channel according to a grant-free transmission from the UE 110

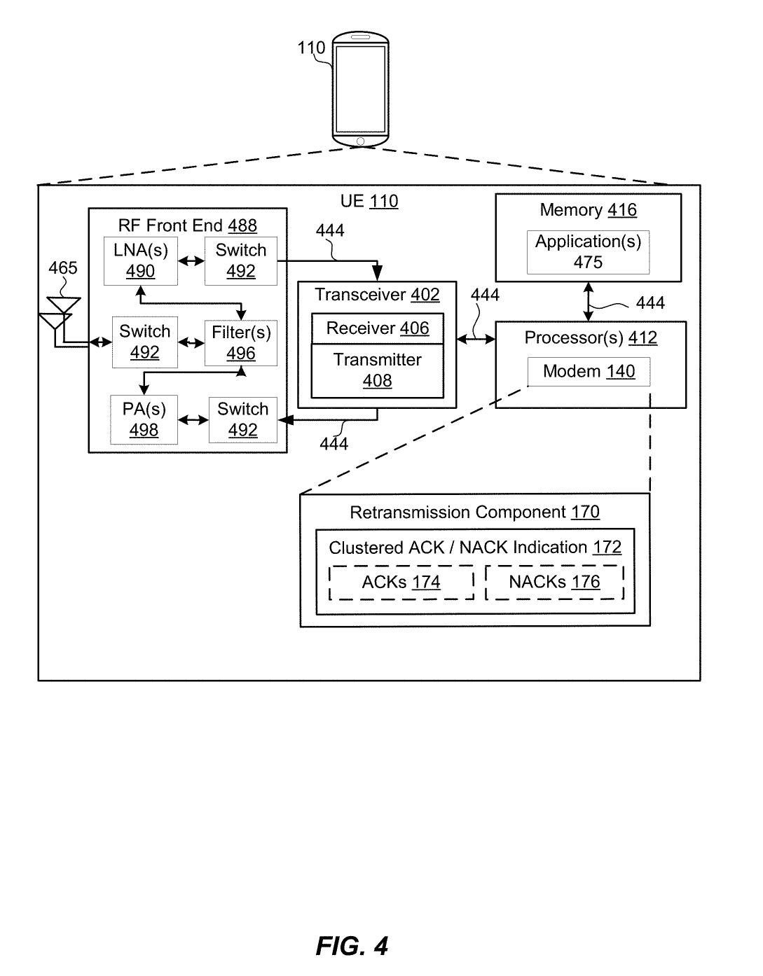

Referring to FIG. 4, one example of an implementation of UE 110 may include a variety of components, some of which have already been described above, but including components such as one or more processors 412 and memory 416 and transceiver 402 in communication via one or more buses 444, which may operate in conjunction with modem 140 and retransmission component 170 to enable one or more of the functions described herein related to transmitting or retransmitting data based on receiving a clustered ACK/NACK indication 172. Further, the one or more processors 412, modem 414, memory 416, transceiver 402, radio frequency (RF) front end 488 and one or more antennas 465, may be configured to support voice and/or data calls (simultaneously or non-simultaneously) in one or more radio access technologies. In some aspects, the modem 414 may be the same as or similar to the modem 414.

In an aspect, the one or more processors 412 can include a modem 414 that uses one or more modem processors. The various functions related to resource identification component 150 may be included in modem 140 and/or processors 412 and, in an aspect, can be executed by a single processor, while in other aspects, different ones of the functions may be executed by a combination of two or more different processors. For example, in an aspect, the one or more processors 412 may include any one or any combination of a modem processor, or a baseband processor, or a digital signal processor, or a transmit processor, or a receiver processor, or a transceiver processor associated with transceiver 402. In other aspects, some of the features of the one or more processors 412 and/or modem 140 associated with resource identification component 150 may be performed by transceiver 402.

The memory 416 may be configured to store data used herein and/or local versions of applications 475 or retransmission component 170 and/or one or more of the subcomponents being executed by at least one processor 412. Memory 416 can include any type of computer-readable medium usable by a computer or at least one processor 412, such as random access memory (RAM), read only memory (ROM), tapes, magnetic discs, optical discs, volatile memory, non-volatile memory, and any combination thereof. In an aspect, for example, memory 416 may be a non-transitory computer-readable storage medium that stores one or more computer-executable codes defining resource identification component 150 and/or one or more of its subcomponents, and/or data associated therewith, when UE 110 is operating at least one processor 412 to execute retransmission component 170 and/or one or more of its subcomponents.

Transceiver 402 may include at least one receiver 406 and at least one transmitter 408. Receiver 406 may include hardware, firmware, and/or software code executable by a processor for receiving data, the code comprising instructions and being stored in a memory (e.g., computer-readable medium). Receiver 406 may be, for example, a RF receiver. In an aspect, receiver 406 may receive signals transmitted by at least one base station 125. Additionally, receiver 406 may process such received signals, and also may obtain measurements of the signals, such as, but not limited to, Ec/Io, SNR, RSRP, RSSI, etc. Transmitter 408 may include hardware, firmware, and/or software code executable by a processor for transmitting data, the code comprising instructions and being stored in a memory (e.g., computer-readable medium). A suitable example of transmitter 408 may include, but is not limited to, an RF transmitter.

Moreover, in an aspect, UE 110 may include RF front end 488, which may operate in communication with one or more antennas 465 and transceiver 402 for receiving and transmitting radio transmissions, for example, wireless communications transmitted by at least one base station 125 or wireless transmissions transmitted by UE 110. RF front end 488 may be communicatively coupled with one or more antennas 465 and can include one or more low-noise amplifiers (LNAs) 490, one or more switches 492, one or more power amplifiers (PAs) 498, and one or more filters 1296 for transmitting and receiving RF signals.

In an aspect, LNA 490 can amplify a received signal at a desired output level. In an aspect, each LNA 490 may have a specified minimum and maximum gain values. In an aspect, RF front end 488 may use one or more switches 492 to select a particular LNA 490 and its specified gain value based on a desired gain value for a particular application.

Further, for example, one or more PA(s) 498 may be used by RF front end 488 to amplify a signal for an RF output at a desired output power level. In an aspect, each PA 498 may have specified minimum and maximum gain values. In an aspect, RF front end 488 may use one or more switches 492 to select a particular PA 498 and a corresponding specified gain value based on a desired gain value for a particular application.

Also, for example, one or more filters 1296 can be used by RF front end 488 to filter a received signal to obtain an input RF signal. Similarly, in an aspect, for example, a respective filter 1296 can be used to filter an output from a respective PA 498 to produce an output signal for transmission. In an aspect, each filter 1296 can be communicatively coupled with a specific LNA 490 and/or PA 498. In an aspect, RF front end 488 can use one or more switches 492 to select a transmit or receive path using a specified filter 1296, LNA 490, and/or PA 498, based on a configuration as specified by transceiver 402 and/or processor 412.

As such, transceiver 402 may be configured to transmit and receive wireless signals through one or more antennas 465 via RF front end 488. In an aspect, transceiver may be tuned to operate at specified frequencies such that UE 110 can communicate with, for example, one or more base stations 125 or one or more cells associated with one or more base stations 125. In an aspect, for example, modem 140 can configure transceiver 402 to operate at a specified frequency and power level based on the UE configuration of the UE 110 and the communication protocol used by modem 140.

In an aspect, modem 140 can be a multiband-multimode modem, which can process digital data and communicate with transceiver 402 such that the digital data is sent and received using transceiver 402. In an aspect, modem 140 can be multiband and be configured to support multiple frequency bands for a specific communications protocol. In an aspect, modem 140 can be multimode and be configured to support multiple operating networks and communications protocols. In an aspect, modem 140 can control one or more components of UE 110 (e.g., RF front end 488, transceiver 402) to enable transmission and/or reception of signals from the network based on a specified modem configuration. In an aspect, the modem configuration can be based on the mode of the modem and the frequency band in use. In another aspect, the modem configuration can be based on UE configuration information associated with UE 110 as provided by the network during cell selection and/or cell reselection.

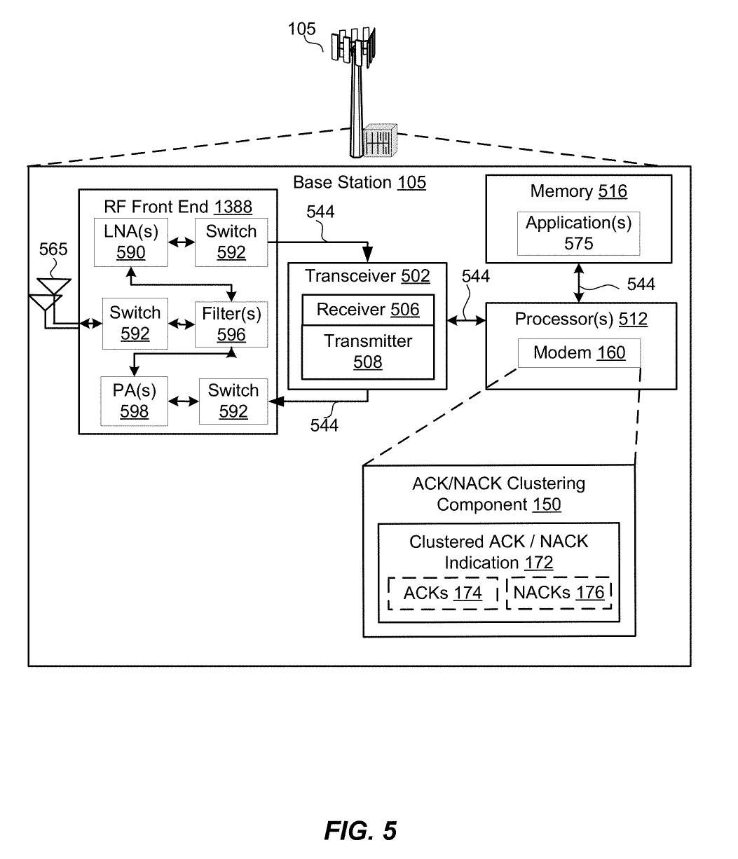

Referring to FIG. 5, one example of an implementation of base station 105 may include a variety of components, some of which have already been described above, but including components such as one or more processors 512, a memory 516, and a transceiver 502 in communication via one or more buses 544, which may operate in conjunction with modem 160 and ACK/NACK clustering component 150 to enable one or more of the functions described herein relating to clustering or grouping ACK/NACK data according to a clustering scheme.

The transceiver 502, receiver 506, transmitter 508, one or more processors 512, memory 516, applications 575, buses 544, RF front end 588, LNAs 590, switches 592, filters 596, PAs 598, and one or more antennas 565 may be the same as or similar to the corresponding components of UE 110, as described above, but configured or otherwise programmed for base station operations as opposed to UE operations.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method of wireless communications at a user equipment (UE), comprising:
transmitting, on an uplink communication channel, one or more data packets to a network entity; and
receiving, on a downlink communication channel, a clustered acknowledgment (ACK)/negative ACK (NACK) indication from the network entity in response to transmitting the one or more data packets on the uplink communication channel.

2. The method of claim 1, wherein the UE is associated with a UE-specific index value identifying one or more associated ACKs or NACKs within the clustered ACK/NACK indication.

3. The method of claim 2, further comprising:
determining, based on the UE-specific index value, whether at least one ACK or NACK associated with the transmission of the one or more data packets is included within the clustered ACK/NACK indication;
in accordance with a determination that the clustered ACK/NACK indication includes at least one ACK, forgoing retransmission of at least one of the one or more data packets to the network entity; and
in accordance with a determination that the clustered ACK/NACK indication includes at least one NACK, retransmitting at least one of the one or more data packets to the network entity.

4. The method of claim 2, wherein the UE-specific index is based on at least one of a radio resource control (RRC) configuration or a physical uplink shared channel (PUSCH) transmission.

5. The method of claim 1, wherein transmitting, on the uplink communication channel, the one or more data packets includes transmitting the one or more data packets within a number of mini-slots.

6. The method of claim 5, wherein each of the number of mini-slots is associated with a distinct index value, the method further comprising:
determining whether the clustered ACK/NACK indication includes at least one ACK or NACK for each of the number of mini-slots used in transmitting the one or more data packets based on the distinct index values;
in accordance with a determination that the clustered ACK/NACK indication includes at least one ACK for at least one of the number of mini-slots, forgoing retransmission of at least one of the one or more data packets to the network entity; and
in accordance with a determination that the clustered ACK/NACK indication includes at least one NACK for at least one of the number of mini-slots, retransmitting at least one of the one or more data packets to the network entity.

7. The method of claim 1, wherein the transmission of the one or more data packets on the uplink communication channel corresponds to a grant-free transmission.

8. The method of claim 1, wherein transmitting, on the uplink communication channel, the one or more data packets to the network entity includes transmitting the one or more data packets according to a Multiple-Input Multiple-Output (MIMO) configuration.

9. The method of claim 8, wherein receiving, on the downlink communication channel, the clustered ACK/NACK indication from the network entity includes receiving the clustered ACK/NACK indication per codeword or for both codewords.

10. The method of claim 1, wherein the clustered ACK/NACK indication is frequency subband dependent.

11. The method of claim 1, wherein the clustered ACK/NACK indication is received at a predetermined time after transmitting the one or more data packets to the network entity.

12. The method of claim 1, wherein the clustered ACK/NACK indication is coupled with a hybrid automatic repeat request (HARQ) process identifier.

13. A method wireless communications at a network entity, comprising:
receiving, on an uplink communication channel, one or more data packets from a user equipment (UE); and
transmitting, on a downlink communication channel, a clustered acknowledgment (ACK)/negative ACK (NACK) indication from the network entity in response to receiving the one or more data packets on the uplink communication channel.

14. The method of claim 13, wherein transmitting the clustered ACK/NACK indication includes transmitting one or more ACKs or NACKs each associated with a UE-specific index value.

15. The method of claim 13, wherein transmitting the clustered ACK/NACK indication includes transmitting one or more ACKs or NACKs each associated with an index value of a corresponding mini-slot.

16. A user equipment (UE) for wireless communication, comprising:
a memory; and
at least one processor in communication with the memory, wherein the at least one processor is configured to: transmit, on an uplink communication channel, one or more data packets to a network entity; and
receive, on a downlink communication channel, a clustered acknowledgment (ACK)/negative ACK (NACK) indication from the network entity in response to transmitting the one or more data packets on the uplink communication channel.

17. The UE of claim 16, wherein the UE is associated with a UE-specific index value identifying one or more associated ACKs or NACKs within the clustered ACK/NACK indication.

18. The UE of claim 17, wherein the at least one processor is further configured to:
determine, based on the UE-specific index value, whether at least one ACK or NACK associated with the transmission of the one or more data packets is included within the clustered ACK/NACK indication;
in accordance with a determination that the clustered ACK/NACK indication includes at least one ACK, forgo retransmission of at least one of the one or more data packets to the network entity; and
in accordance with a determination that the clustered ACK/NACK indication includes at least one NACK, retransmit at least one of the one or more data packets to the network entity.

19. The UE of claim 17, wherein the UE-specific index is based on at least one of a radio resource control (RRC) configuration or a physical uplink shared channel (PUSCH) transmission.

20. The UE of claim 16, wherein, transmitting, on the uplink communication channel, the one or more data packets includes transmitting the one or more data packets within a number.

21. The UE of claim 20, wherein each of the number of mini-slots is associated with a distinct index value, and wherein the at least one processor is further configured to:
determine whether the clustered ACK/NACK indication includes at least one ACK or NACK for each of the number of mini-slots used in transmitting the one or more data packets based on the distinct index values; in accordance with a determination that the clustered ACK/NACK indication includes at least one ACK for at least one of the number of mini-slots, forgo retransmission of at least one of the one or more data packets to the network entity; and
in accordance with a determination that the clustered ACK/NACK indication includes at least one NACK for at least one of the number of mini-slots, retransmit at least one of the one or more data packets to the network entity.

22. The UE of claim 16, wherein the transmission of the one or more data packets on the uplink communication channel corresponds to a grant-free transmission.

23. The UE of claim 16, wherein to transmit, on the uplink communication channel, the one or more data packets to the network entity, the at least one processor is further configured to transmit the one or more data packets according to a Multiple-Input Multiple-Output (MIMO) configuration.

24. The UE of claim 23, wherein to receive, on the downlink communication channel, the clustered ACK/NACK indication from the network entity, the at least one processor is further configured to receive the clustered ACK/NACK indication per codeword or for both codewords.

25. The UE of claim 16, wherein the clustered ACK/NACK indication is frequency subband dependent.

26. The UE of claim 16, wherein the clustered ACK/NACK indication is received at a predetermined time after transmitting the one or more data packets to the network entity.

27. The UE of claim 16, wherein the clustered ACK/NACK indication is coupled with a hybrid automatic repeat request (HARQ) process identifier.

28. A network entity for wireless communication, comprising:
a memory; and
at least one processor in communication with the memory, wherein the at least one processor is configured to:
receive, on an uplink communication channel, one or more data packets from a user equipment (UE); and
transmit, on a downlink communication channel, a clustered acknowledgment (ACK)/negative ACK (NACK) indication from the network entity in response to receiving the one or more data packets on the uplink communication channel.

29. The method of claim 28, wherein transmitting the clustered ACK/NACK indication includes transmitting one or more ACKs or NACKs each associated with a UE-specific index value.

30. The method of claim 28, wherein transmitting the clustered ACK/NACK indication includes transmitting one or more ACKs or NACKs each associated with an index value of a corresponding mini-slot.
